(19) United States
(12) Patent Application Publication
(10) Pub. No.: US 2021/0356794 A1
(43) Pub. Date: Nov. 18, 2021

(54) LIQUID CRYSTAL MODULE AND PREPARATION METHOD THEREOF

(71) Applicant: TCL CHINA STAR OPTOELECTRONICS TECHNOLOGY CO., LTD., Shenzhen, Guangdong (CN)

(72) Inventors: Yun YU, Shenzhen (CN); Qingyong ZHU, Shenzhen (CN)

(21) Appl. No.: 16/615,367

(22) PCT Filed: Sep. 18, 2019
(86) PCT No.: PCT/CN2019/106352

§ 371 Date: Nov. 20, 2019

(30) Foreign Application Priority Data
Jun. 27, 2019 (CN) 201910564506.8

(51) Int. Cl. G02F 1/1345; G02F 1/1333; G02F 1/1335; F21V 8/00

(52) U.S. Cl. CPC G02F 1/13452; G02F 1/133345; G02F 1/133528; G02F 2202/28; G02F 1/133354; G02B 6/0088; G02F 1/133317; G02F 1/133512

(57) ABSTRACT

A liquid crystal module is provided. The liquid crystal module includes a display panel including a first substrate and a second substrate both aligned with a box, wherein the first substrate is flush with the second substrate in a bonding area, and wherein signal lines of the first substrate are exposed in a flush position to form signal terminals; a conductive adhesive layer covered with a shading adhesive; and a driving unit including a driving chip connected to the signal terminals through the conductive adhesive layer.

### BACKGROUND OF DISCLOSURE

### 1. Field of Disclosure

The present disclosure relates to the field of display technology, and more particularly, to a liquid crystal module and a preparation method thereof.

### 2. Description of Related Art

Currently, an ultra-narrow border design for display panels meets the people's demand for artistic shape of display panel.

One side of a panel needs to be connected to a driving signal and a testing signal. In general, there is a need to adopt an external bonding area (i.e., signal lines with projections between 1 micrometer and 2 micrometers) at one side connected to the signal lines. In the display panels, because lengths of a first substrate and a second substrate are different, a ladder area is formed. A chip-on film is disposed at an end or the bottom of the first substrate. The ladder area is coated and filled with black ink so that light reflected from metal of the end of the first substrate is prevented. Such display panels have the ladder area, and a driving unit is disposed in the ladder area, restricting the further compression of sizes of the display panels.

Therefore, it is required to design a novel structure to solve the technical problems of restricting the further compression of sizes of the display panels and also ensuring the reliability of driving signals of the display panels, due to the ladder area existing in conventional display panels and the driving unit disposed in the ladder area.

### SUMMARY

The object of the present disclosure is to provide a liquid crystal module and a preparation method thereof, which can solve the technical problems of restricting the further compression of sizes of the display panels and also ensuring the reliability of driving signals of the display panels, due to the ladder area existing in conventional display panels and the driving unit disposed in the ladder area.

In order to solve the above problems, the present disclosure provides a liquid crystal module, including: a display panel including a first substrate and a second substrate both aligned with a box, wherein the first substrate is flush with the second substrate in a bonding area, and wherein signal lines of the first substrate are exposed in a flush position to form signal terminals; a conductive adhesive layer; a shading adhesive; a driving unit including a driving chip connected to the signal terminals through the conductive adhesive layer; a backlight module including a middle frame including barricades and support plates perpendicular to the barricades, wherein the support plates are configured to support the display panel; a black adhesive tape located between the support plates and the display panel; and a polarizer including a first polarizer and a second polarizer disposed on a surface and a bottom surface of the display panel respectively.

The conductive adhesive layer includes a first insulation layer, a conductive layer, and a second insulation layer.

A plurality of through holes are disposed on surfaces of the first insulation layer and the second insulation layer.

The conductive layer includes a plurality of signal processing units having a plurality of lead pins configured to be connected to the signal terminals and the driving unit.

Shapes of the plurality of signal processing units include one or more of a circle, an oval, a rectangle, a parallelogram, a trapezoid, a triangle, and irregular planar figures.

The conductive adhesive layer sticks to an end surface or a bottom surface of one side of the first substrate.

A first flush face and a second flush face are disposed at two ends of the first substrate and the second substrate respectively, and wherein the conductive adhesive layer includes a first conductive adhesive layer, disposed on the first flush face, and a second conductive adhesive layer, disposed on the second flush face.

In order to solve the above problems, the present disclosure further provides a method of preparing a liquid crystal module, including:

disposing a first substrate and a second substrate in alignment with a box in a display panel, and cutting a part of the first substrate, extending outside the second substrate, with a laser beam to form a flush position;

grinding the flush position with a grinder to expose signal lines of the first substrate in the flush position so that signal terminals are formed;

preparing a conductive adhesive layer in the flush position, and disposing a driving unit in order that a driving chip is connected to the signal terminals through the conductive adhesive layer; and

assembling the display panel to a backlight module.

The step of preparing the conductive adhesive layer in the flush position, and disposing the driving unit in order that the driving chip is connected to the signal terminals through the conductive adhesive layer includes:

preparing a first insulation layer on a surface in the flush position, and imposing stresses and mechanical power on the first insulation layer to form a plurality of through holes;

printing or coating a conductive layer on the first insulation layer, and patterning the conductive layer through a dry etching process to form a plurality of signal processing units, wherein each of the plurality of signal processing units has a plurality of exposed lead pins; and

preparing a second insulation layer on a surface of the conductive layer, imposing stresses and mechanical power on the second insulation layer to form a plurality of through holes, and coating a shading adhesive on a surface of the second insulation layer.

The step of grinding the flush position with the grinder to expose the signal lines of the first substrate in the flush position so that the signal terminals are formed includes:

sticking a first polarizer and a second polarizer on the bottom of the first substrate and a surface of the second substrate respectively; and

cutting a part of the second polarizer, near one end of the conductive adhesive layer, with a laser, and sticking a black adhesive tape in a position where the stuck second polarizer is eliminated.

The beneficial effect of the present disclosure is that, in a border area of the display panel, one end of a color film substrate is aligned with one end of an array substrate, further compressing sizes of border of the display panel. One side of the conductive adhesive layer is connected to exposed signal terminals, the other side of the conductive adhesive layer is connected to the driving unit, and the driving unit is disposed outside the display panel. Thus, the space of the border area is saved, benefiting the accomplishment of a liquid crystal module with an ultra-narrow border or without a border. Also, the reliability of driving signals in the display panel can be ensured.

### BRIEF DESCRIPTION OF DRAWINGS

In order to more clearly explain the technical solutions in the embodiments of the present disclosure, the accompanying drawings used in the description of the embodiments are introduced simply below. It is obvious that the accompanying drawings in the following description are merely a part of the embodiments of the present disclosure. A person having ordinary skill in this field can also obtain other accompanying drawings according to the accompanying drawings under the premise of not paying creative works.

FIG. 1 is a schematic structural diagram of a liquid crystal module according to an embodiment of the present disclosure.

FIG. 2 is a schematic structural diagram of a conductive adhesive layer according to an embodiment of the present disclosure.

FIG. 3 is a schematic structural diagram of a first insulation layer in a conductive adhesive layer according to an embodiment of the present disclosure.

FIG. 4 is a schematic structural diagram of a conductive layer in a conductive adhesive layer according to an embodiment of the present disclosure.

FIG. 5 is a partially schematic structural diagram of another liquid crystal module according to an embodiment of the present disclosure.

FIG. 6 is a flowchart illustrating a method of preparing a liquid crystal module according to an embodiment of the present disclosure.

### DETAILED DESCRIPTION OF EMBODIMENTS

In conjunction with accompanying drawings and embodiments, the present disclosure will be further described in detail below. It is particularly pointed out that the following embodiments are merely used to explain the present disclosure without limiting the scope of the present disclosure. Also, the following embodiments are a part of the embodiments of the present disclosure instead of all of the embodiments. A person having ordinary skill in this field can obtain other embodiments under the premise of not paying creative works, and all of these embodiments should be within the protective scope of the present disclosure.

For the technical problems of restricting the further compression of sizes of the display panels and also ensuring the reliability of driving signals of the display panels, due to the ladder area existing in conventional display panels and the driving unit disposed in the ladder area, the present embodiment can solve the deficiency.

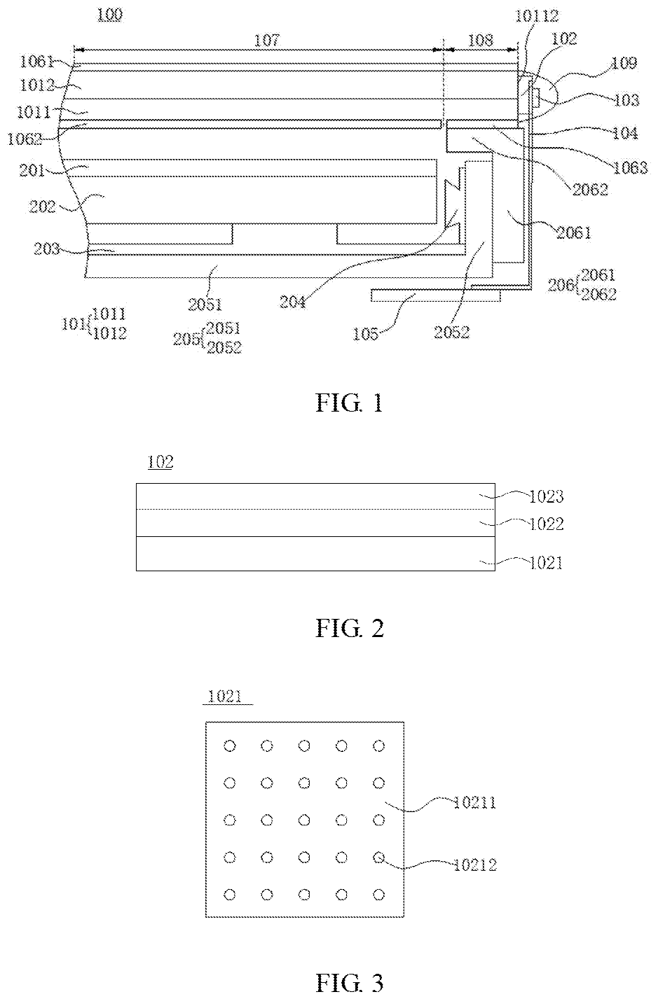

As shown in FIG. 1, an embodiment of the present disclosure provides a liquid crystal module 100, including a display panel 101 including a first substrate 1011 and a second substrate 1012 both aligned with a box, wherein the first substrate 1011 is flush with the second substrate 1012 in a bonding area, and wherein signal lines of the first substrate 1011 are exposed in a flush position to form signal terminals; a conductive adhesive layer 102; a shading adhesive 109; a driving unit 103 including a driving chip connected to the signal terminals through the conductive adhesive layer 102; a backlight module including a middle frame 206 including barricades 2061 and support plates 2062 perpendicular to the barricades 2061, wherein the support plates 2062 are configured to support the display panel 101; a black adhesive tape 1063 located between the support plates 2062 and the display panel 101; and a polarizer 206 including a first polarizer 1061 and a second polarizer 1062 disposed on a surface and a bottom surface of the display panel 101 respectively.

Specifically, the embodiment of the present disclosure provides the liquid crystal module 100, including the display panel 101 and a corresponding backlight module. The display panel 101 includes a display area 107 and a border area 108 surrounding the display area 107. The first substrate 1011 and the second substrate 1012 are both aligned with a box, i.e., extending from the display area 107 to edges of the border area 108 and forming a flush position 10112. Signal terminals are exposed in the flush position 10112 of the first substrate 1011. The conductive adhesive layer 102 is disposed on a surface of the signal terminals. A signal processing unit is connected to the exposed signal terminals in the middle of one side of the conductive adhesive layer 102, near the display panel 101, and the opposite side of the conductive adhesive layer 102 is connected to the driving unit 103. The driving unit 103 includes the driving chip including at least one of a gate driving circuit, a static electricity protecting circuit, and a data signal circuit. The driving chip is used as a source driver and a gate driver in the display panel to output data signals. The data signals are transmitted to the display panel through the conductive adhesive layer 102 in order to drive the display panel to display. One side of the conductive adhesive layer 102 perpendicular and connected to the driving unit 103 is connected to a chip-on film 104. The other end of the chip-on film 104 connected to a printed circuit board (PCB) is responsible for receiving the data signals transmitted from the printed circuit board. Thus, the reliability of driving signals in the display panel is realized, and the size of the bonding area is reduced, which benefits the accomplishment of the liquid crystal module 100 with an ultra-narrow border or without a border.

The conductive adhesive layer 102 sticks to an end surface of the first substrate 1011 and the second substrate 1012 in the flush position 10112 and acts as a bridge to transmit signals, ensuring that driving circuits can be disposed outside the display panel 101. According to practical demands, in the border area 108 in the present embodiment, one end of the first substrate 1011 can also be not disposed in alignment with one end of the second substrate 1012, and the conductive adhesive layer 102 sticks to an end surface or a bottom surface of the first substrate 1011.

The conductive adhesive layer 102 is covered with the shading adhesive 109. Preferably, the overall thickness of the shading adhesive 109 is between 0.03 micrometer and 0.5 micrometer. The shading adhesive 109 includes a multilayered inorganic insulation layer and an organic buffer layer which overlap each other. After the shading adhesive 109 being pasted, short circuits, cascaded circuits, and other bad phenomena can be prevented from occurring in electrical signals of the chip-on film between the conductive adhesive layer 102 and the driving circuits. The shading adhesive 109 does not affect the thickness of the liquid crystal module 100. In a process of pasting, the inorganic insulation layer and the organic buffer layer do not slide due to their same shapes, guaranteeing the planarity and performances of the liquid crystal module 100.

The black adhesive tape 1063 is disposed at the bottom of the first substrate 1011 near one side of the conductive adhesive layer 102. The second polarizer 1062 is disposed on the bottom surface of the display panel 101, and the first polarizer 1061 is disposed on the surface of the display panel 101. In the border area 108, terminals of the first polarizer 1061 exposed outside the second substrate 1012 are between 3 micrometers and 5 micrometers. The edge of the first polarizer 1061 which tends to one side of the second substrate is even and artistic. The second polarizer 1062 is not disposed at the bottom of the border area 108. The black adhesive tape 1063 is stuck in a reserved and predetermined position and sticks to the bottom of the first substrate 1011. Preferably, a thickness of the black adhesive tape 1063 is the same as that of the adjacent second polarizer 1062. The black adhesive tape 1063 prevents light from leaking from film layers between the first substrate 1011 and the second substrate 1012, above the black adhesive tape 1063, and the outside of the backlight module. The problem that the backlight module leaks light can be improved effectively, thereby improving display effects and quality of picture of the whole backlight module.

In the present embodiment, the liquid crystal module 100 further includes a back plate 205 including a bottom plate 2051 and side plates 2052, wherein the bottom plate 2051 and the side plates 2052 form a containing cavity, wherein a hollow area is formed at the bottom of the containing cavity, and wherein a printed circuit board 105 is disposed in the hollow area; a reflective plate 203 located above the bottom plate 2051 and used to reflect light leaking from the containing cavity back; a light source 204 disposed on a surface of the side plates 2052 to realize a super-thin module; a light guide plate 202 located above the reflective plate 203, wherein a horizontal central line of the light guide plate 202 is aligned with a center of the light source 204, and wherein the light guide plate 202 is used to transform a point source or a line source, which the light source 204 emits, to a surface source required by the display panel 101; and an optical film 201 located above the light guide plate 202 and used to gather and emit light which a diffusion plate 201 emits in a predetermined scope, improving a brightness of the backlight module. The optical film 201 generally includes a prism sheet and a brightness enhancement film. The prism sheet is a light focusing device for gathering and emitting diffuse light in a predetermined angular scope using the laws of total reflection and refraction, thereby improving a brightness in the emitting scope and the brightness of the backlight module. The middle frame 206 is located on side faces of the side plates 2052. The middle frame 206 includes the barricades 2061 and the support plates 2062. The barricades 2061 are used to protect the backlight module 300 and to prevent invasions of liquids, gases, or solid particles. The support plates 2062 support the display panel 101 on the backlight module.

As shown in FIG. 2, the conductive adhesive layer 102 includes a first insulation layer 1021, a conductive layer 1022, and a second insulation layer 1023. The conductive layer 1022 is sandwiched in a laminated structure between the first insulation layer 1021 and the second insulation layer 1023. A plurality of through holes are disposed in positions where the first insulation layer 1021 corresponds to the second insulation layer 1023. A thickness of the first insulation layer 1021 is the same as that of the second insulation layer 1023. The thickness can be between a few micrometers and a few hundred micrometers. The thicknesses of the first insulation layer 1021 and the second insulation layer 1023 can also be not identical. The thickness of the first insulation layer 1021 is a multiple of that of the second insulation layer 1023, such as at least 25%, 50%, 75%, 100%, 150%, or 200%. In some specific implementation plans, the thickness of the first insulation layer 1021 is not greater than a multiple of that of the second insulation layer, i.e., 200%, 300%, 400%, 500%, 600%, 700%, 800%, 900%, or 1000%. In some specific implementation plans, for instance, the thickness of the first insulation layer 1021 can be approximately between 10 micrometers and 500 micrometers, and the thickness of the second insulation layer 1023 can be approximately between 5 micrometers and 200 micrometers.

The first insulation layer 1021 and the second insulation layer 1023 include thermoplastic layers made of one or more of thermoplastic materials. The thermoplastic materials can include polyester and derivatives thereof, such as polyester, polybutylene terephthalate, copolyester, etc. The thermoplastic materials can also include polyamide, copolyimide, and so on. The thermoplastic materials can further include polyethylene, polypropylene, ethylene acrylic acid, ethylene vinyl acetate, ethylene acrylic acid, etc.

As shown in FIG. 3, the first insulation layer 1021 has a relatively lower viscosity, and through holes 10212 can be formed by imposing stresses and mechanical power on a surface of a film layer 10211. The through holes 10212 are used to connect the conductive layer 1022 and exposed signals of the first substrate 1011. In the present embodiment, the first insulation layer 1021 and the second insulation layer 1023 are similar in structure. The through holes in the second insulation layer 1023 are used to connect the conductive layer 1022, the driving unit 103, and the chip-on film 104.

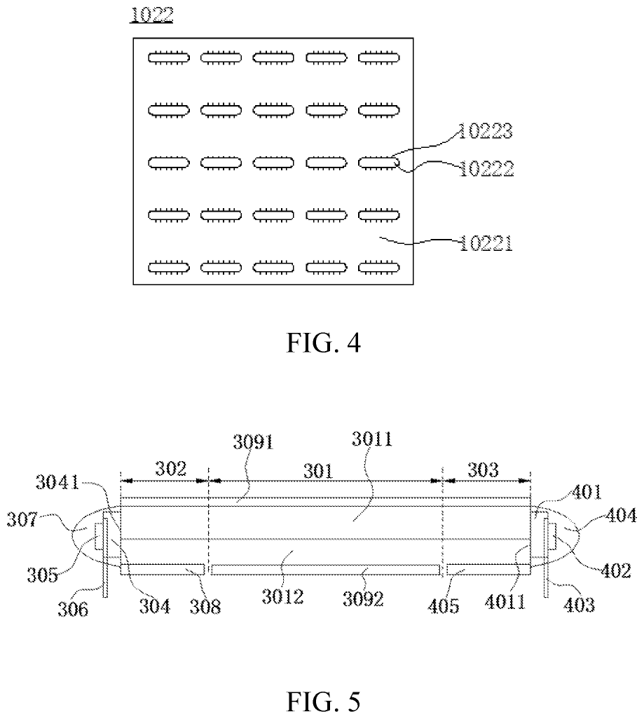

As shown in FIG. 4, the conductive layer 1022 is a porous conductive layer and includes a circuit board 10221 and a plurality of signal processing units 10222 distributed in an array. The signal processing units 10222 are used as relay stations to transmit information. Each of the signal processing units 10222 has a plurality of lead pins 10223 connected to the exposed signals of the first substrate 1011, the driving unit 103, and the chip-on film 104. A plurality of gaps are disposed between the signal processing units 10222. Shapes of the signal processing units 10222 include one or more of a circle, an oval, a rectangle, a parallelogram, a trapezoid, a triangle, and irregular planar figures. The materials of the conductive layer 1022 include, for instance, nickel, copper, silver, conductive particles, thin sheets, or fibers, etc. Meshed carbon-based fibers and/or particles can enhance the conductivity and the grounding performance of the conductive layer.

In an embodiment of the present disclosure, a first flush face and a second flush face can also be disposed at two ends of the first substrate and the second substrate respectively. The conductive adhesive layer includes a first conductive adhesive layer, disposed on the first flush face, and a second conductive adhesive layer, disposed on the second flush face.

As shown in FIG. 5, which is a partially schematic structural diagram of another liquid crystal module according to an embodiment of the present disclosure. In the schematic diagram, an additional flush position is disposed on a basis of the first substrate and the second substrate in FIG. 1. In the present embodiment, a third polarizer 3091 and a fourth polarizer 3092 are stuck at two sides of the display panel. A first border area 302 and a second border area 303 are disposed at two sides of a display area 301. In the first border area 302, a first substrate 3012 and a second substrate 3011 extend to edges of the first border area 302 respectively, and a first flush face 3012 is formed. In the second border area 303, the first substrate 3012 and the second substrate 3011 extend to edges of the second border area 303 respectively, and a second flush face 4011 is formed. A first conductive adhesive layer 304 and a second conductive adhesive layer 401 are disposed on the first flush face 3012 and the second flush face 4011 respectively. A first driving unit 305 and a second driving unit 402 are disposed on the first conductive adhesive layer 304 and the second conductive adhesive layer 401 respectively. The other side face of the first conductive adhesive layer 305 is connected to a first chip-on film 306. A first shading layer 307 is disposed on an outer surface of the first conductive adhesive layer 305. The other side face of the second conductive adhesive layer 401 is connected to a second chip-on film 403. A shading layer 404 is disposed on the second conductive adhesive layer 401. A first black adhesive tape 308 and a second black adhesive tape 405 are disposed at the bottom of the first border area 302 and the bottom of the second border area 303 respectively.

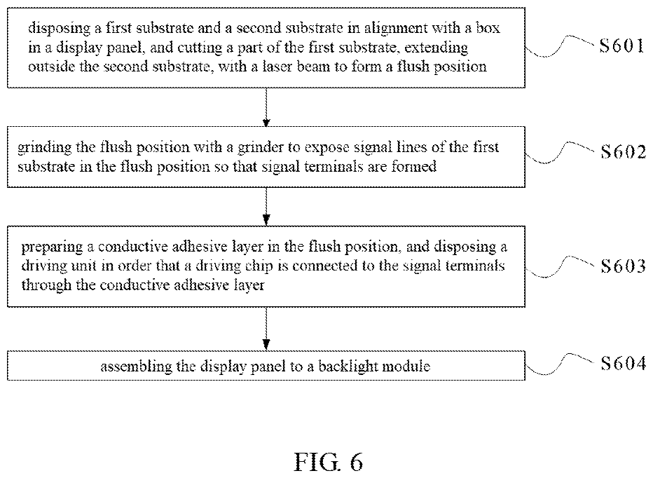

As shown in FIG. 6, a method of preparing a liquid crystal module, provided according to the above liquid crystal module, includes the following steps:

Step S601: disposing a first substrate and a second substrate in alignment with a box in a display panel, and cutting a part of the first substrate, extending outside the second substrate, with a laser beam to form a flush position;

Step S602: grinding the flush position with a grinder to expose signal lines of the first substrate in the flush position so that signal terminals are formed;

Step S603: preparing a conductive adhesive layer in the flush position, and disposing a driving unit in order that a driving chip is connected to the signal terminals through the conductive adhesive layer; and

Step S604: assembling the display panel to a backlight module.

Preferably, the step of preparing the conductive adhesive layer in the flush position, and disposing the driving unit in order that the driving chip is connected to the signal terminals through the conductive adhesive layer specifically includes:

preparing a first insulation layer on a surface in the flush position, and imposing stresses and mechanical power on the first insulation layer to form a plurality of through holes;

printing or coating a conductive layer on the first insulation layer, and patterning the conductive layer through a dry etching process to form a plurality of signal processing units, wherein each of the plurality of signal processing units has a plurality of exposed lead pins; and

preparing a second insulation layer on a surface of the conductive layer, imposing stresses and mechanical power on the second insulation layer to form a plurality of through holes, and coating a shading adhesive on a surface of the second insulation layer.

Preferably, the step of grinding the flush position with the grinder to expose the signal lines of the first substrate in the flush position so that the signal terminals are formed specifically includes:

sticking a first polarizer and a second polarizer on the bottom of the first substrate and a surface of the second substrate respectively; and

cutting a part of the second polarizer, near one end of the conductive adhesive layer, with a laser, and sticking a black adhesive tape in a position where the stuck second polarizer is eliminated.

In the border area of the display panel, one end of a color film substrate is aligned with one end of an array substrate, further compressing sizes of border of the display panel. One side of the conductive adhesive layer is connected to exposed signal terminals, the other side of the conductive adhesive layer is connected to the driving unit, and the driving unit is disposed outside the display panel. Thus, the space of the border area is saved, benefiting the accomplishment of a liquid crystal module with an ultra-narrow border or without a border. Also, the reliability of driving signals in the display panel can be ensured.

In conclusion, although the present disclosure has been described with reference to the foregoing preferred embodiments thereof, it is not limited to the foregoing preferred embodiments. It is apparent to those skilled in the art that a variety of modifications and changes may be made without departing from the scope of the present disclosure which is intended to be defined by the appended claims.

What is claimed is:

1. A liquid crystal module, comprising:
a display panel comprising a first substrate and a second substrate both aligned with a box, wherein the first substrate is flush with the second substrate in a bonding area, and wherein signal lines of the first substrate are exposed in a flush position to form signal terminals;
a conductive adhesive layer;
a shading adhesive;
a driving unit comprising a driving chip connected to the signal terminals through the conductive adhesive layer;
a backlight module comprising a middle frame comprising barricades and support plates perpendicular to the barricades, wherein the support plates are configured to support the display panel;
a black adhesive tape located between the support plates and the display panel; and
a polarizer comprising a first polarizer and a second polarizer disposed on a surface and a bottom surface of the display panel respectively.

2. The liquid crystal module of claim 1, wherein the conductive adhesive layer comprises a first insulation layer, a conductive layer, and a second insulation layer.

3. The liquid crystal module of claim 2, wherein a plurality of through holes are disposed on surfaces of the first insulation layer and the second insulation layer.

4. The liquid crystal module of claim 2, wherein the conductive layer comprises a plurality of signal processing units having a plurality of lead pins configured to be connected to the signal terminals and the driving unit.

5. The liquid crystal module of claim 4, wherein shapes of the plurality of signal processing units comprise one or more of a circle, an oval, a rectangle, a parallelogram, a trapezoid, a triangle, and irregular planar figures.

6. The liquid crystal module of claim 1, wherein the conductive adhesive layer sticks to an end surface or a bottom surface of one side of the first substrate.

7. The liquid crystal module of claim 1, wherein a first flush face and a second flush face are disposed at two ends of the first substrate and the second substrate respectively, and wherein the conductive adhesive layer comprises a first conductive adhesive layer, disposed on the first flush face, and a second conductive adhesive layer, disposed on the second flush face.

8. A method of preparing a liquid crystal module, comprising:
disposing a first substrate and a second substrate in alignment with a box in a display panel, and cutting a part of the first substrate, extending outside the second substrate, with a laser beam to form a flush position;
grinding the flush position with a grinder to expose signal lines of the first substrate in the flush position so that signal terminals are formed;
preparing a conductive adhesive layer in the flush position, and disposing a driving unit in order that a driving chip is connected to the signal terminals through the conductive adhesive layer; and
assembling the display panel to a backlight module.

9. The method of claim 8, wherein the step of preparing the conductive adhesive layer in the flush position, and disposing the driving unit in order that the driving chip is connected to the signal terminals through the conductive adhesive layer comprises:
preparing a first insulation layer on a surface in the flush position, and imposing stresses and mechanical power on the first insulation layer to form a plurality of through holes;
printing or coating a conductive layer on the first insulation layer, and patterning the conductive layer through a dry etching process to form a plurality of signal processing units, wherein each of the plurality of signal processing units has a plurality of exposed lead pins; and
preparing a second insulation layer on a surface of the conductive layer, imposing stresses and mechanical power on the second insulation layer to form a plurality of through holes, and coating a shading adhesive on a surface of the second insulation layer.

10. The method of claim 8, wherein the step of grinding the flush position with the grinder to expose the signal lines of the first substrate in the flush position so that the signal terminals are formed comprises:
sticking a first polarizer and a second polarizer on the bottom of the first substrate and a surface of the second substrate respectively; and
cutting a part of the second polarizer, near one end of the conductive adhesive layer, with a laser, and sticking a black adhesive tape in a position where the stuck second polarizer is eliminated.
